(19) United States
(12) Patent Application Publication
(10) Pub. No.: US 2016/0328004 A1
(43) Pub. Date: Nov. 10, 2016

(54) ELECTRONIC DEVICE AND INDICATION CIRCUIT THEREFOR

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: MENG-LIANG YANG, Shenzhen (CN)

(21) Appl. No.: 14/750,495

(22) Filed: Jun. 25, 2015

(30) Foreign Application Priority Data
May 8, 2015 (CN) 201510231596.0

(51) Int. Cl. G06F 1/32

(52) U.S. Cl. CPC G06F 1/3287; G06F 1/3243

(57) ABSTRACT

An indication circuit indicates a first power supply unit and a second power supply unit working in either a 1+1 or a 2+0. The indication circuit includes a first MCU, a second MCU, a first light-emitting diode, and a second light-emitting diode. When the first MCU and the second MCU determine that the power supply units are working in the first operation mode, the first light-emitting diode and second light-emitting diode are made to flicker synchronously. When it is determined that the power supply units are working in the second operation mode, the diodes are made to flicker asynchronously.

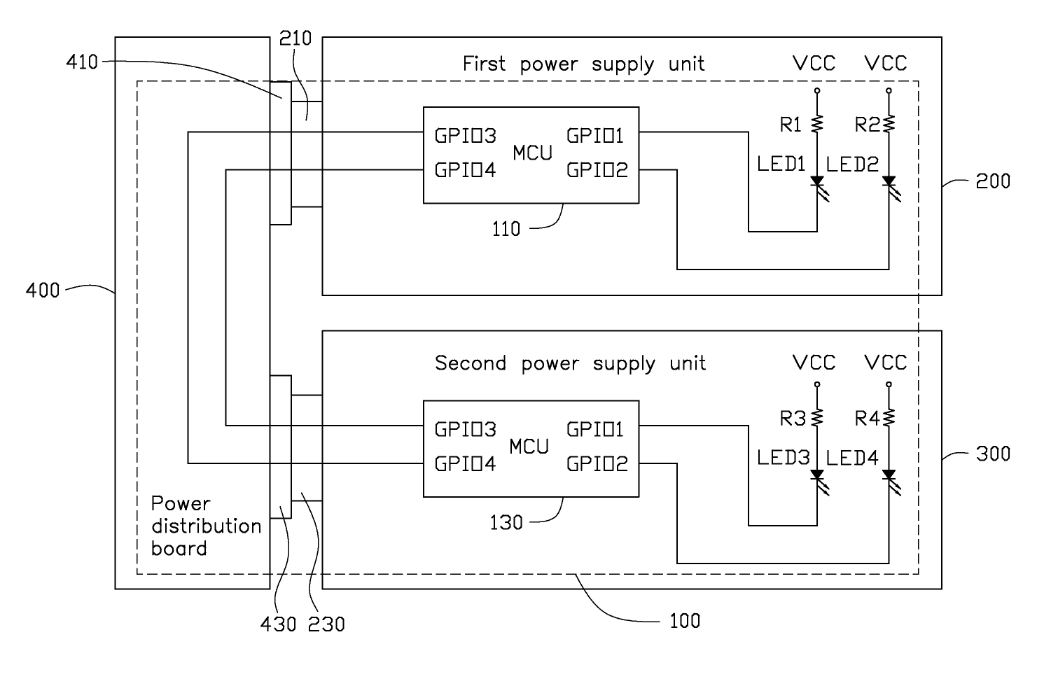

### FIELD

The subject matter herein generally relates to indication circuits.

### BACKGROUND

Power supply units of a server system usually operate in a 1+1 operation mode or a 2+0 operation mode. In the 1+1 operation mode, two power supply units are connected in parallel, and both output half power to the server system. When one of the two power supply units is down, the other power supply unit will output more power to ensure the server system continues operating normally. When the server system needs more power, the two power supply units are operated in a 2+0 operation mode. In the 2+0 operation mode, the two power supply units are connected in series, and both output full power to the server system. However, a user cannot see whether the two power supply units are working in the 1+1 operation mode or in the 2+0 operation mode. When the two power supply units work in the 2+0 operation mode, if the user unplugs one of the two power supply units, the server system cannot operate normally.

### BRIEF DESCRIPTION OF THE DRAWING

Implementations of the present technology will now be described, by way of example only, with reference to the attached FIGURE.

The FIGURE is a circuit diagram of an embodiment of a circuit in an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawing is not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure relates to an indication circuit.

The FIGURE illustrates an embodiment of an electronic device 1000. The electronic device 1000 can comprise an indication circuit 100, a first power supply unit 200, a second power supply unit 300, and a power distribution board 400. The first power supply unit 200 is electrically coupled to the second power supply unit 300 through the power distribution board 400. The indication circuit 100 is positioned in the first power supply unit 200 and the second power supply unit 300, and electrically coupled to the first power supply unit 200 and the second power supply unit 300. The indication circuit 100 indicates that the first power supply unit 200 and the second power supply unit 300 are working in a first operation mode or in a second operation mode.

In at least one embodiment, the first operation mode is a 1+1 operation mode, and the first power supply unit 200 and the second power supply unit 300 are coupled in parallel. Both output half power. The second operation mode is a 2+0 operation mode, and the first power supply unit 200 and the second power supply unit 300 are coupled in series. Both output full power. For example, if a maximum output power of each of the first power supply unit 200 and the second power supply unit 300 is 1200 W, the combined output power of the first power supply unit 200 and the second power supply unit 300 is 1200 W when the first power supply unit 200 and the second power supply unit 300 work in the first operation mode. The combined output power of the first power supply unit 200 and the second power supply unit 300 is 2400 W when the first power supply unit 200 and the second power supply unit 300 are working in the second operation mode.

The first power supply unit 200 can comprise a connector 210, and the second power supply unit 300 can comprise a connector 230. The power distribution board 400 can comprise two connectors 410 and 430. When the connector 210 is electrically coupled to the connector 410 and the connector 230 is electrically coupled to the connector 430, the first power supply unit 200 is electrically coupled to the second power supply unit 300 through the power distribution board 400. In at least one embodiment, each of the connectors 210 and 230 is an edge connector, and each of the connectors 410 and 430 is a slot to receive the edge connector.

The indication circuit 100 can comprise two Micro Controller Units (MCU) 110 and 130, four light-emitting diodes LED1, LED2, LED3, and LED4, and four resistors R1, R2, R3, and R4. The MCU 110 and the MCU 130 can determine whether the first power supply unit 200 and the second power supply unit 300 are working in a first operation mode or in a second operation mode, according to signals output by the first power supply unit 200 and the second power supply unit 300. In at least one embodiment, the MCU 110 and the resistors R1 and R2 are positioned in the first power supply unit 200. The light-emitting diodes LED1 and LED2 are positioned on the first power supply unit 200 for convenient viewing. The MCU 130 and the resistors R3 and R4 are positioned in the second power supply unit 300, and the light-emitting diodes LED3 and LED4 are also positioned for visibility on the second power supply unit 300.

The MCU 110 can comprise three output pins GPIO1, GPIO2, and GPIO3, and an input pin GPIO4. The MCU 130 can comprise the same three output pins and the same input pin. The output pin GPIO1 of the MCU 110 is electrically coupled to a cathode of the light-emitting diode LED1, and an anode of the light-emitting diode LED1 is electrically coupled to a power supply VCC through the resistor R1. The output pin GPIO2 of the MCU 110 is electrically coupled to a cathode of the light-emitting diode LED2, and an anode of the light-emitting diode LED2 is electrically coupled to the power supply VCC through the resistor R2. The output pin GPIO3 of the MCU 110 is electrically coupled to the input pin GPIO4 of the MCU 130 through the power distribution board 400, and the input pin GPIO4 of the MCU 110 is electrically coupled to the output pin GPIO3 of the MCU 130 through the power distribution board 400. The output pin GPIO1 of the MCU 130 is electrically coupled to a cathode of the light-emitting diode LED3, and an anode of the light-emitting diode LED3 is electrically coupled to the power supply VCC through the resistor R3. The output pin GPIO2 of the MCU 130 is electrically coupled to a cathode of the light-emitting diode LED4, and an anode of the light-emitting diode LED4 is electrically coupled to the power supply VCC through the resistor R4. In at least one embodiment, the light-emitting diodes LED1 and LED3 emit green light when illuminated, and the light-emitting diodes LED2 and LED4 emit red light when illuminated.

When the MCU 110 and the MCU 130 determine that the first power supply unit 200 and the second power supply unit 300 are working in the first operation mode, the output pins GPIO1 and GPIO3 output the same control signal. In at least one embodiment, the control signal can be a pulse signal. The output pin GPIO1 of the MCU 110 outputs the pulse signal to make the light-emitting diode LED1 flicker, and the output pin GPIO3 of the MCU 110 outputs the pulse signal to the input pin GPIO4 of the MCU 130 through the power distribution board 400. The input pin GPIO4 of the MCU 130 transports the pulse signal to the output pins GPIO1 and GPIO3 of the MCU 130. The output pin GPIO1 of the MCU 130 outputs the pulse signal to make the light-emitting diode LED3 flicker, and the output pin GPIO3 of the MCU 130 outputs the pulse signal to the input pin GPIO4 of the MCU 110 through the power distribution board 400. In the first operation mode, the light-emitting diodes LED1 and LED3 flicker synchronously, to indicate that the first power supply unit 200 and the second power supply unit 300 are working in the first operation mode.

When the MCU 110 and the MCU 130 determine that the first power supply unit 200 and the second power supply unit 300 are working in the second operation mode, the output pins GPIO1 and GPIO3 output the same control signal. In at least one embodiment, the control signal can be a pulse signal. The output pin GPIO1 of the MCU 110 outputs the pulse signal to make the light-emitting diode LED1 flicker, and the output pin GPIO3 of the MCU 110 outputs the pulse signal to the input pin GPIO4 of the MCU 130 through the power distribution board 400. The input pin GPIO4 of the MCU 130 inverts the pulse signal and outputs the inverted signal to the output pins GPIO1 and GPIO3 of the MCU 130. The output pin GPIO1 of the MCU 130 outputs the inverted pulse signal to make the light-emitting diode LED3 flicker, and the output pin GPIO3 of the MCU 130 outputs the inverted pulse signal to the input pin GPIO4 of the MCU 110 through the power distribution board 400. In the second operation mode, the light-emitting diodes LED1 and LED3 flicker asynchronously, to indicate that the first power supply unit 200 and the second power supply unit 300 are working in the second operation mode.

When the MCU 110 determines that the first power supply unit 200 works in an over-current mode or an overvoltage protection mode, the output pin GPIO2 of the MCU 110 outputs a signal to illuminate the light-emitting diode LED2. When the MCU 130 determines that the second power supply unit 300 is working in the over-current or overvoltage protection mode, the output pin GPIO2 of the MCU 130 outputs a signal to illuminate the light-emitting diode LED4.

When the MCU 110 determines that the first power supply unit 200 is working in a standby mode, the output pin GPIO2 of the MCU 110 outputs a pulse signal to make the light-emitting diode LED2 flicker. When the MCU 130 determines that the second power supply unit 300 is working in the standby mode, the output pin GPIO2 of the MCU 130 outputs a pulse signal to make the light-emitting diode LED4 flicker.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. An indication circuit configured to indicate a first power supply unit and a second power supply unit working in a first operation mode or a second operation mode, the indication circuit comprising:
a first MCU;
a second MCU electrically coupled to the first MCU;
a first light-emitting diode electrically coupled to the first MCU; and
a second light-emitting diode electrically coupled to the second MCU;
wherein the first MCU and the second MCU are configured such that in event that the first MCU and the second MCU determine that the first power supply unit and the second power supply unit are working in the first operation mode, the first MCU outputs a pulse signal to the first light-emitting diode and the second MCU, the second MCU outputs the pulse signal to the second light-emitting diode, and the first light-emitting diode and the second light-emitting diode flicker synchronously;
wherein the first MCU and the second MCU are further configured such that in event that the first MCU and the second MCU determine that the first power supply unit and the second power supply unit are working in the second operation mode, the first MCU outputs the pulse signal to the first light-emitting diode and the second MCU, the second MCU inverts the pulse signal and outputs the inverted pulse signal to the second light-emitting diode, and the first light-emitting diode and the second light-emitting diode flicker asynchronously.

2. The indication circuit of claim 1, wherein the first MCU comprises a first output pin and a second output pin, the second MCU comprises a first input pin and a third output pin, an anode of the first light-emitting diode is electrically coupled to a power supply, a cathode of the first light-emitting diode is electrically coupled to the first output pin, an anode of the second light-emitting diode is electrically coupled to the power supply, a cathode of the second light-emitting diode is electrically coupled to the third output pin, the second output pin is electrically coupled to the first input pin;
wherein the first MCU and the second MCU are configured such that in event that the first MCU and the second MCU determine that the first power supply unit and the second power supply unit are working in the first operation mode, the first output pin of the first MCU outputs the pulse signal to the first light-emitting diode to make the first light-emitting diode flicker, the second output pin of first MCU outputs the pulse signal to the first input pin of the second MCU, the first input pin of the second MCU transports the pulse signal to the third output pin, the third output pin outputs the pulse signal to the second light-emitting diode to make the second light-emitting diode flicker, and the first light-emitting diode and the second light-emitting diode flicker synchronously;
wherein the first MCU and the second MCU are further configured such that in event that the first MCU and the second MCU determine that the first power supply unit and the second power supply unit are working in the second operation mode, the first output pin of the first MCU outputs the pulse signal to the first light-emitting diode to make the first light-emitting diode flicker, the second output pin of first MCU outputs the pulse signal to the first input pin of the second MCU, the second MCU inverts the pulse signal and outputs the inverted pulse signal to the third output pin, the third output pin outputs the inverted pulse signal to the second light-emitting diode to make the second light-emitting diode flicker, and the first light-emitting diode and the second light-emitting diode flicker asynchronously.

3. The indication circuit of claim 2, wherein the first MCU further comprises a second input pin, the second MCU further comprises a fourth output pin, the second input pin is electrically coupled to the fourth output pin; in event that the third output pin of the second MCU receives the pulse signal, the fourth output pin receives the pulse signal and outputs the pulse signal to the second input pin; in event that the third output pin of the second MCU receives the inverted pulse signal, the fourth output pin receives the inverted pulse signal and outputs the inverted pulse signal to the second input pin.

4. The indication circuit of claim 1, wherein the indication circuit further comprises a third light-emitting diode and a fourth light-emitting diode, the first MCU further comprises a fifth output pin, the second MCU further comprises a sixth output pin, an anode of the third light-emitting diode is electrically coupled to the power supply, a cathode of the third light-emitting diode is electrically coupled to the fifth output pin, an anode of the fourth light-emitting diode is electrically coupled to the power supply, a cathode of the fourth light-emitting diode is electrically coupled to the sixth output pin, when the first MCU determines that the first power supply unit is working in an over-current mode or an overvoltage protection mode, the fifth output pin of the first MCU outputs a signal to the third light-emitting diode to illuminate the third light-emitting diode; when the second MCU determines that the second power supply unit is working in the over-current mode or the overvoltage protection mode, the sixth output pin of the second MCU outputs a signal to the fourth light-emitting diode to illuminate the fourth light-emitting diode; when the first MCU determines that the first power supply unit is working in a standby mode, the fifth output pin of the first MCU outputs a signal to the third light-emitting diode to make the third light-emitting diode flicker; and when the second MCU determines that the second power supply unit is working in the standby mode, the sixth output pin of the second MCU outputs a signal to the fourth light-emitting diode to make the fourth light-emitting diode flicker.

5. The indication circuit of claim 4, wherein the first light-emitting diode and the second light-emitting diode emit green light when illuminated; and the third light-emitting diode and the fourth light-emitting diode emit red light when illuminated.

6. An electronic device comprising:
a first power supply unit;
a power distribution board;
a second power supply unit electrically coupled to the first power supply unit through the power distribution board; and
an indication circuit configured to indicate the first power supply unit and the second power supply unit working in a first operation mode or a second operation mode, the indication circuit comprising:
a first MCU;
a second MCU electrically coupled to the first MCU;
a first light-emitting diode electrically coupled to the first MCU; and
a second light-emitting diode electrically coupled to the second MCU;
wherein the first MCU and the second MCU are configured such that in event that the first MCU and the second MCU determine that the first power supply unit and the second power supply unit are working in the first operation mode, the first MCU outputs a pulse signal to the first light-emitting diode and the second MCU, the second MCU outputs the pulse signal to the second light-emitting diode, and the first light-emitting diode and the second light-emitting diode flicker synchronously;
wherein the first MCU and the second MCU are further configured such that in event that the first MCU and the second MCU determine that the first power supply unit and the second power supply unit are working in the second operation mode, the first MCU outputs the pulse signal to the first light-emitting diode and the second MCU, the second MCU inverts the pulse signal and outputs the inverted pulse signal to the second light-emitting diode, and the first light-emitting diode and the second light-emitting diode flicker asynchronously.

7. The electronic device of claim 6, wherein the first MCU comprises a first output pin and a second output pin, the second MCU comprises a first input pin and a third output pin, an anode of the first light-emitting diode is electrically coupled to a power supply, a cathode of the first light-emitting diode is electrically coupled to the first output pin, an anode of the second light-emitting diode is electrically coupled to the power supply, a cathode of the second light-emitting diode is electrically coupled to the third output pin, the second output pin is electrically coupled to the first input pin;
wherein the first MCU and the second MCU are configured such that in event that the first MCU and the second MCU determine that the first power supply unit and the second power supply unit are working in the first operation mode, the first output pin of the first MCU outputs the pulse signal to the first light-emitting diode to make the first light-emitting diode flicker, the second output pin of first MCU outputs the pulse signal to the first input pin of the second MCU, the first input pin of the second MCU transports the pulse signal to the third output pin, the third output pin outputs the pulse signal to the second light-emitting diode to make the second light-emitting diode flicker, and the first light-emitting diode and the second light-emitting diode flicker synchronously;
wherein the first MCU and the second MCU are configured such that in event that the first MCU and the second MCU determine that the first power supply unit and the second power supply unit are working in the second operation mode, the first output pin of the first MCU outputs the pulse signal to the first light-emitting diode to make the first light-emitting diode flicker, the second output pin of first MCU outputs the pulse signal to the first input pin of the second MCU, the second MCU inverts the pulse signal and outputs the inverted pulse signal to the third output pin, the third output pin outputs the inverted pulse signal to the second light-emitting diode to make the second light-emitting diode flicker, and the first light-emitting diode and the second light-emitting diode flicker asynchronously.

8. The electronic device of claim 7, wherein the first MCU further comprises a second input pin, the second MCU further comprises a fourth output pin, the second input pin is electrically coupled to the fourth output pin; in event that the third output pin of the second MCU receives the pulse signal, the fourth output pin receives the pulse signal and outputs the pulse signal to the second input pin; in event that the third output pin of the second MCU receives the inverted pulse signal, the fourth output pin receives the inverted pulse signal and outputs the inverted pulse signal to the second input pin.

9. The electronic device of claim 6, wherein the indication circuit further comprises a third light-emitting diode and a fourth light-emitting diode, the first MCU further comprises a fifth output pin, the second MCU further comprises a sixth output pin, an anode of the third light-emitting diode is electrically coupled to a power supply, a cathode of the third light-emitting diode is electrically coupled to the fifth output pin, an anode of the fourth light-emitting diode is electrically coupled to the power supply, a cathode of the fourth light-emitting diode is electrically coupled to the sixth output pin, when the first MCU determines that the first power supply unit is working in an over-current mode or an overvoltage protection mode, the fifth output pin of the first MCU outputs a signal to the third light-emitting diode to illuminate the third light-emitting diode; when the second MCU determines that the second power supply unit is working in the over-current mode or the overvoltage protection mode, the sixth output pin of the second MCU outputs a signal to the fourth light-emitting diode to illuminate the fourth light-emitting diode; when the first MCU determines that the first power supply unit is working in a standby mode, the fifth output pin of the first MCU outputs a signal to the third light-emitting diode to make the third light-emitting diode flicker; and when the second MCU determines that the second power supply unit is working in the standby mode, the sixth output pin of the second MCU outputs a signal to the fourth light-emitting diode to make the fourth light-emitting diode flicker.

10. The electronic device of claim 9, wherein the first light-emitting diode and the second light-emitting diode emit green light when illuminated; and the third light-emitting diode and the fourth light-emitting diode emit red light when illuminated.
